(19) United States
(12) Patent Application Publication
(10) Pub. No.: US 2001/0041604 A1
(43) Pub. Date: Nov. 15, 2001

(54) Method for charging secondary battery incorporated in handset of cordless telephone

(76) Inventor: Tomoyuki Ogasawara, Saitama (JP)

Correspondence Address: JAY H. MAIOLI, Cooper & Dunham LLP, 1185 Avenue of the Americas, New York, NY, 10036, US

(21) Appl. No.: 09/817,071

(22) Filed: Mar. 26, 2001

(30) Foreign Application Priority Data
Mar. 28, 2000 (JP) P2000-089263

(51) Int. Cl. H04M 1/00

(52) U.S. Cl. 455/573; 320/107

(57) ABSTRACT

A current from a constant-current charger is supplied as a charging current to the secondary battery incorporated in the handset of the cordless telephone. The charging current to the secondary battery is controlled by changing a receiving time of a receiving circuit of the handset in accordance with a time passed in the charging. The receiving circuit of the handset is in parallel connection with the secondary battery as viewed from the constant-current charger.

### BACKGROUND OF THE INVENTION

1. Field of the Invention

The present invention relates to a method for charging a secondary battery incorporated in a handset of a cordless telephone.

2. Description of the Related Art

Generally, a handset of a cordless telephone incorporates a secondary battery such as a Ni—Cd battery for driving the handset. Conventionally, when the secondary battery incorporated in the handset of the cordless phone is charged by a battery charger, a method called quick charging is used.

In the quick charging method, the secondary battery is supplied with a relatively large charging current such as 0.3C for a predetermined time from a commencement of the charging, and thereafter, the charging current is reduced to a relatively small current to perform a trickle charging.

Thus, a conventional battery charger must include a switching circuit to switch between the large current and the small current and a charging circuit for each of the large and small currents, resulting in a problem of complex constitution and an expensive price.

It is therefore an object of the present invention to provide a method for charging the secondary battery incorporated in the handset of the cordless telephone by using a battery charger of a relatively simple constitution.

### SUMMARY OF INVENTION

According to the present invention, a method for charging a secondary battery incorporated in a handset of a cordless telephone is characterized in that a current from a constant-current charger is supplied as a charging current to the secondary battery incorporated in the handset of the cordless telephone, and the charging current to the secondary battery is controlled by changing receiving time of a receiving circuit of the handset in accordance with the passage of time for the charging, the receiving circuit of the handset being in parallel connection with the secondary battery when viewed from the constant-current charger.

According to the present invention, a charging equivalent to a quick charging is achieved by using the constant-current charger and by changing the receiving time of the receiving circuit of the handset in accordance with the passage of time for the charging while controlling the charging current to the second battery. Therefore, the secondary battery can be charged sufficiently by using an inexpensive constant-current battery charger of a simple constitution.

### BRIEF DESCRIPTION OF THE DRAWINGS

FIG. 1 is a block diagram for description of a method for charging a secondary battery incorporated in a handset of a cordless telephone as an embodiment of the present invention;

FIG. 2 is a flowchart for description of the present invention; and

FIG. 3 is a graph for description of the present invention.

### DETAILED DESCRIPTION OF THE PREFERRED EMBODIMENTS

Hereinafter, an embodiment of the method for charging a secondary battery incorporated in a handset of a cordless telephone according to the present invention will be described with reference to the attached figures.

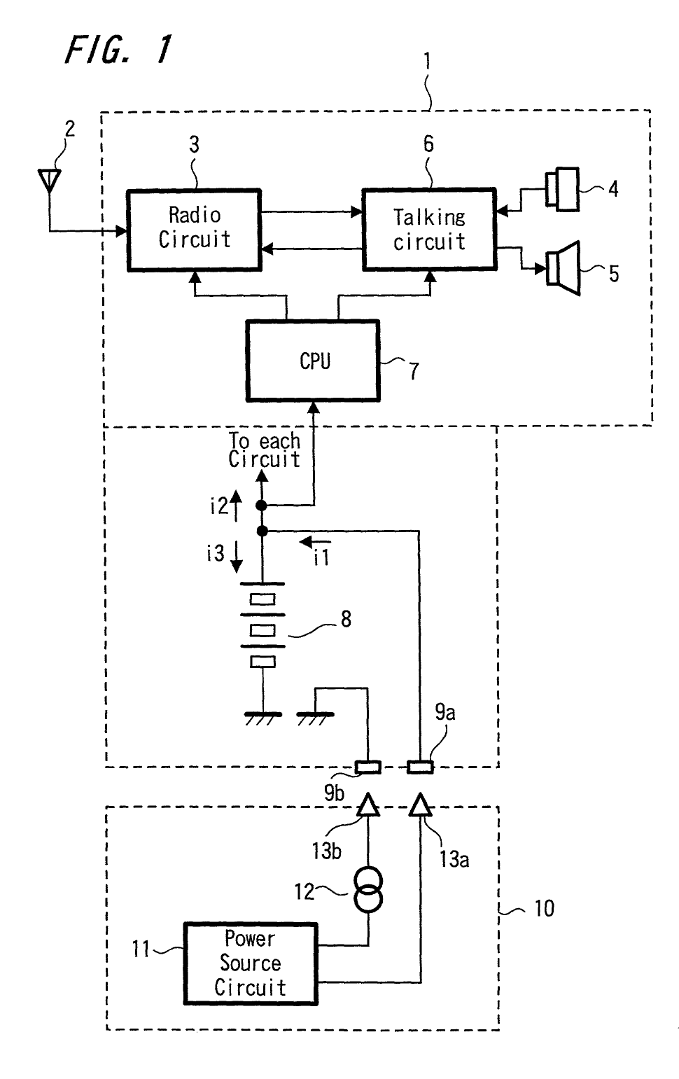

Referring first to FIG. 1, a numeral code 1 indicates a handset of a cordless telephone. The handset 1 comprises a radio circuit 3 connected with an antenna 2 for radio communication with a base unit which is connected with a telephone link, and a talking circuit 6 connected with the radio circuit 3 via two-way transmission line and including a microphone 4 serving as a transmitter and a speaker 5 serving as a receiver.

Referring also to FIG. 1, a numeral 7 indicates a central processing unit (CPU) provided by a microcomputer. The central processing unit 7 can control a receiving circuit, i.e. the radio circuit 3 and the talking circuit 6 of the handset 1, in a way that they alternate between a receiving mode and a standby mode for every predetermined period of time. The central processing unit 7 is provided with a predetermined timer capability.

The handset 1 is provided therein with a secondary battery 8 such as a Ni—Cd battery. The secondary battery 8 has a positive terminal connected with a power supply terminal of each of the radio circuit 3, the talking circuit 6, the central processing unit 7 and so on of the handset 1. The secondary battery 8 has a negative terminal grounded.

The positive terminal of the secondary battery 8 is also connected with a charging terminal 9a exposed outside of a casing of the handset 1. The negative terminal of the secondary battery has a grounding terminal connected with a charging terminal 9b exposed outside of the casing of the handset 1.

Referring again to FIG. 1, a numeral 10 indicates a constant-current charger. The constant-current charger 10 includes a power source circuit 11 for obtaining a predetermined direct-current power from a commercial power source, and a constant-current circuit 12. The power source circuit 11 has an output terminal connected, via the constant-current circuit 12, with a charging terminal 13b, which is to connect to the charging terminal 9b of the handset 1 at a time of charging. The power source circuit 11 has another output terminal connected with a charging terminal 13a, which is to connect to the charging terminal 9a of the handset 1 at the time of charging.

According to the present embodiment, the constant-current charging circuit 10 supplies a constant current i1 of 300 mA, for example, as a quick charging current. When the constant-current charger 10 charges the secondary battery 8 of the handset 1, the handset 1 is placed at a predetermined position of the constant-current charger 10. At this time, the charging terminals 9a, 9b of the handset 1 are connected with the corresponding charging terminals 13a, 13b of the constant-current charger 10.

In this case, when viewed from the constant-current charger 10, the secondary battery 8 and the receiving circuit (the radio circuit 3, the talking circuit 6, the central processing unit (CPU) 7 and so on) of the handset 1 are in a parallel connection. Thus, a charging current i3 supplied to the secondary battery 8 is given by the following expression, where i2 represents a handset current consumed by the handset 1.

i3=i1−i2

The handset current i2 consumed by the handset 1 includes a operating current i2 which, for example, is 200 mA when receiving an electric wave from the base unit, and a standby current which, for example, is 1 μA when the receiving circuit of the handset 1 is turned off.

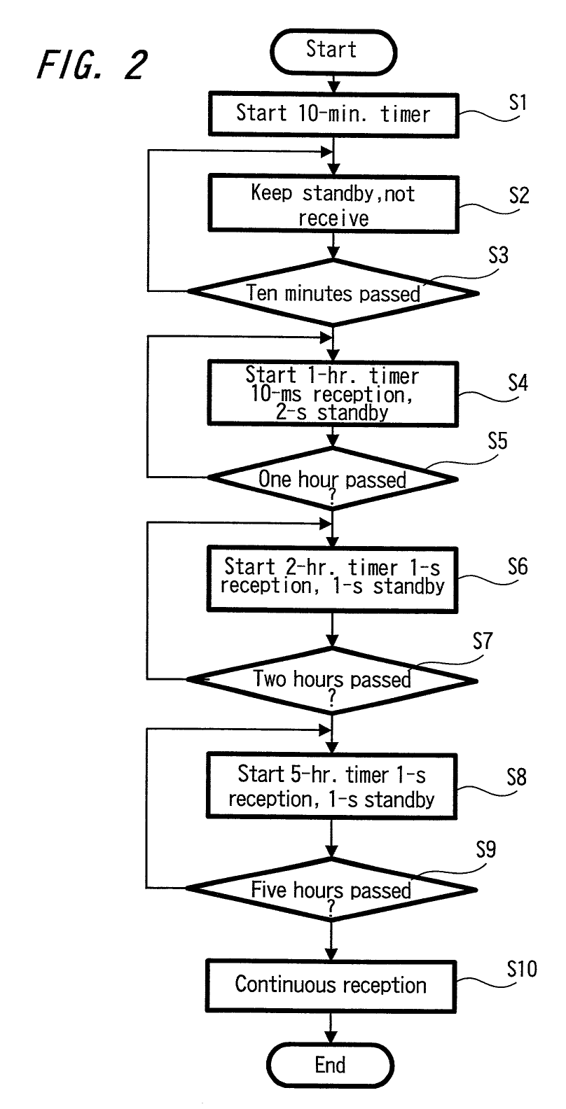

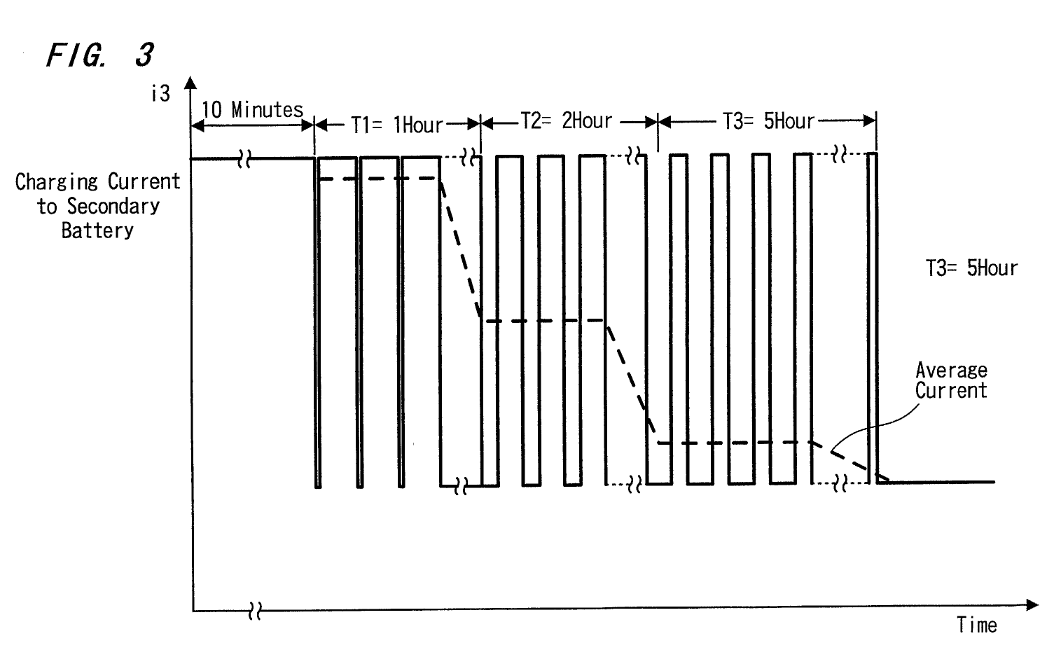

According to the present embodiment, the charging of the secondary battery 8 incorporated in the handset 1 of the cordless phone is controlled by the central processing unit (CPU) 7 of the handset 1 according to a pattern shown in FIG. 2 and FIG. 3. Specifically, upon commencement of the charging, the timer is started to measure ten minutes for example, as a time T₀ (Step S1). Until the time T₀, i.e. the 10 minutes according to this example, is passed, the receiving circuit is not turned on, and the handset 1 holds itself in the standby mode (Step S2). At this time, since the handset current i2 is equal to the standby current 1 μA for example, the charging current i3 to the secondary battery 8 is given by the following expression.

i3=i1(300 mA)−i2(1 μA)

Under the situation described above, a quick charging at about 300 mA for example is performed.

Upon passage of the time T₀, or 10 minutes for example, (Step S3), the timer is started to measure one hour for example, as a time T₁ and the handset 1 is set to an intermittent receiving mode in which a pattern of 10 ms receiving mode and 2-second (s) standby mode is repeated (Step S4). The handset current i2 (average) at this time is given by the following expression:

$$i 2 = \frac{( 200 mA \times 10 ms ) + 1 μ A \times 2 s )}{2.01 s} \approx 1 mA$$

Thus, the charging current i3 to the secondary battery 8 is given by the following expression:

i3=300 mA−1 mA=299 mA

In this case, the receiving circuit of the handset 1 is activated for 1 millisecond in every 2.01 seconds to check if there is a call from the base unit. Power consumption under the receiving mode is 200 mA for example, but power consumption under the standby mode is only 1 μA. Therefore, the secondary battery 8 can be protected from exhaustion.

The state of Step S4 is maintained for an hour. Upon passage of the hour (Step S5), the timer is started to measure two hours, for example, as a time T₂ and the handset 1 is set to another intermittent receiving mode in which a pattern of 1-second (s) receiving mode and 1-second (s) standby mode is repeated (Step S6).

The handset current i2 (average) at this time is given by the following expression:

$$i 2 = \frac{( 200 mA \times 1 s ) + 1 μ A \times 1 s )}{2 s} \approx 100 mA$$

Thus, the charging current i3 to the secondary battery 8 is given by the following expression:

i3=300 mA−100 mA=200 mA

Thus, the charging current i3 is controlled.

In this case again, the secondary battery 8 can be protected from exhaustion due to the intermittent receiving.

The state of Step S6 is repeated for two hours. Upon passage of the two hours (Step S7), the timer is started to measure five hours, for example, as a time T₃, and the handset 1 is set to another intermittent receiving mode in which a pattern of 1.5-second (s) receiving mode and 0.5-second (s) standby mode is repeated (Step S8).

The handset current i2 (average) at this time is given by the following expression:

$$i 2 = \frac{( 200 mA \times 1 , 5 ms ) + 1 μ A \times 0.6 s )}{2 s} \approx 150 mA$$

Thus, the charging current i3 to the secondary battery 8 is given by the following expression:

i3=300 mA−150 mA=150 mA

Thus, with the charging current i3 under control, a trickle charging is achieved. In this case again, the secondary battery 8 can be protected from exhaustion, due to the intermittent receiving.

The state of Step S8 is repeated for five hours. Upon passage of the five hours (Step S9), the handset 1 is set to a continuous receiving mode (Step S10).

The handset current i2 at this time is 200 mA, and the charging current i3 to the secondary battery 8 is given by the following expression:

i3=300 mA−200 mA=100 mA

Thus, with the charging current i3 under control, a trickle charging is achieved.

According to the present embodiment, as has been described above, a charging equivalent to a quick charging is achieved by using the constant-current charger 10 and by changing the receiving time of the receiving circuit (the radio circuit 3, the talking circuit 6, the central processing unit 7 and so on) of the handset 1 in accordance with the passage of time for the charging. Therefore, according to the present embodiment, the secondary battery 8 can be charged sufficiently by using an inexpensive constant-current battery charger of a simple constitution.

It should be noted that the according to the embodiment described above, the charging current is supplied in five steps. However, the charging current may of course be supplied in a larger number of steps than five by changing the time of the intermittent receiving mode.

Further, it is obvious that the present invention is not limited to the embodiment described as above, but may have many different constitutions within the scope of the present invention.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A method for charging a secondary battery incorporated in a handset of a cordless telephone, wherein a current from a constant-current charger is supplied as a charging current to the secondary battery incorporated in the handset of the cordless telephone, and the charging current to the secondary battery is controlled by changing a receiving time of a receiving circuit of the handset in accordance with the passage of time for the charging, the receiving circuit of the handset being in parallel connection with the secondary battery as viewed from the constant-current charger.
